(19) United States
(12) Patent Application Publication
(10) Pub. No.: US 2002/0181956 A1
(43) Pub. Date: Dec. 5, 2002

(54) Forms and materials for accident recordation

(76) Inventor: David L. Simpson III, Cherleson, SC (US)

Correspondence Address: John P. Halvonik, Ste. 301, 806 W. Diamond Ave., Gaithersbury, MD, 20878, US

(21) Appl. No.: 09/865,624

(22) Filed: May 29, 2001

(51) Int. Cl. G03B 17/48

(52) U.S. Cl. 396/429

(57) ABSTRACT

An automobile accident recording kit including a 12 exposure single use, camera, with flash included, for recording the scene of a vehicle accidents as well as forms with detailed written instructions to guide the user in the event of an accident. The forms designate the different views that need to be taken of the scene as well as provide vehicle depictions to record point(s) of impact, etc. Such instructions also indicate what information needs to be obtained from the various drivers, witness, and police officers on the scene such as insurance information etc.

### FIELD AND BACKGROUND OF THE INVENTION

The invention relates to the field of paper products and forms for record keeping, and in particular to the field of accident recording and forms for such.

It is believed that providing a form and a guide for recording accident information would be a benefit to those who are involved in traffic accidents and the like as such travelers are often in a state of shock or, at least, anxiety when an accident has happened. Having the proper tools, including a single use camera, a pencil, a form and instructions on how to properly record details of an accident site would be a welcome and useful item to have in the automobile at all times. such item is likely, at minimum, to restore a sense of control or empowerment over the situation. Used as directed, the product would produce an accurate record useful as evidence in making details of the accident known to appropriate inquiring entities, such as police, insurance, etc.

The information on the number of camera exposures and camera angles suggested by the form is based upon interviews with police and insurance professionals and is based upon what is believed to be the most useful and efficacious way in which the motorist can record and present an accurate view of the accident scene to those who need to know.

Having information on what do and what to photograph ready and on hand for the motorist, before the accident happens, will of course save him time and effort in trying to determine this process on his own and will ensure that all the useful and necessary information is recorded. This includes recording that information in a standardized format that in what is essentially a standard operating procedure for law enforcement and insurance entities. without this product, such process may be entirely unfamiliar to a lay person and valuable and useful accident information may be lost.

The invention described herein is believed to be most useful when it is carried in the glove compartment at all times, or other location inside the car as a ready to use aid in the event of an accident in mach the same manner as one carries flares or an emergency medical kit in the car in case of an emergency.

### SUMMARY OF THE INVENTION

An automobile accident recording kit is shown and described herein. The kit includes a single use camera with a situation Specific number of exposures, with a flash attachment, for recording the scene of an accident as well as form with detailed written instructions to guide the user in the event of an accident and a sharpened pencil with which to record the information. The written instructions include directions as to the different views that need to be taken of the scene. Illustrations in the forms indicate where to record with the pencil the points of impact on the vehicle(s).

The written instructions included in the kit indicate how to take the various photos that are deemed necessary to a good accident recording as well as relevant information such as the impact point(s) of the collision, etc. and how this relates to the photographing of the accident. Such instructions also include what information needs to be obtained from the various drivers, witnesses, and police officers on the scene such as insurance information etc. The form also suggests appropriate behavior in the event of injuries, basic legal precautions and other information of a generally useful nature.

It is among the objects of the invention to provide a form and instructions for a person who has just been in an accident to guide them through the stressful experience of successfully recording an accident occurance both in pictures (i.e. photographs) and written form.

It is another objective to provide a kit for recording accident scenes that includes a single use camera, with a specified number of exposures that will correspond to a specific situation. For example; in the case of an automobile accident the insurer may want 8 photos of the accident scene as that is the format processing claims, police and fire investigators may want more or less photos. The camera in the kit would have the number of exposures with this feature in mind, so that the number of exposures corresponds to the type of work that kit is being used for.

It is another objective to provide a kit for recording photos of vehicle accident scenes that is useful and appropriate for law enforcement and insurance authorities as to the number of photos and proper viewing angles of such photos. Another objective is to provide helpful and necessary information for allaying the fears and uncertainties in the mind of a driver or Passenger who has just been in an automobile accident and is not well versed in the technical field of proper accident recording.

Other objectives will be known to those skilled in the art once the invention is shown and described.

### DESCRIPTION OF FIGURES

FIG. 1 instruction sheet to accompany the kit;

FIG. 2 another instruction sheet to accompany the kit,

### DESCRIPTION OF THE PREFERRED EMBODIMENT

The single use camera that goes in the kit is designed with a fixed number of exposures and is loaded with a roll of film having that number of exposures. It is preferred that the number of exposures be 12, which number may vary without violating the spirit of the invention. “Single use cameras” may also be referred to, somewhat incorrectly, as “disposable” cameras.

Each exposure is specifically designated and directed to record a portion of the accident as directed in the form provided in the kit. In the case of a 12 exposure film cartidge, at least 9 of the exposures are designated with a specific shot in mind, as according to the instructions that accompany the camera

Such camera actually used in the kit may be constructed smaller than is customary in the trade to encourage the storage of the kit in the glove box. It should be noted that the size of the camera can vary within the spirit of the invention,

Such a film roll is pre-loaded in the single use camera with the specified number of photos that will make it clear and obvious that the user started with zero exposures on the film roll and he needs to expose all of the film in the camera before he is finished recording the scene. Each of these exposures is specifically designated in the form and each is important and appropriate for the recording of an accident. Because the directions are specific for each exposure of the film, he knows at all times bow many photos he has taken and which he has left to take next (in the suggested numerical order) to form a complete evidentiary record.

Also this number of exposures (along with the written instructions) reminds him that he must finish the entire roll of film in the camera to have an accurate record of the accident. To have an accurate record, he then needs to take the camera to a processing location and submit it for development at once as an evidentiary record of the accident occurrence.

Such single use cameras can be manufactured using routine state of The art equipment, There is no need for special lens or any sort of apparatus that requires more than the usual expertise required of persons skilled in the art of manufacturing cameras.

The kit, as provided, should contain a roll of film in the camera that indeed, has that number of exposures corresponding to field of reconstruction (police, motorist, insurance adjuster, etc.) that the end user works in. The camera and its film are a single unit to the outside observer, as the singe use camera is pre-loaded with this many exposures.

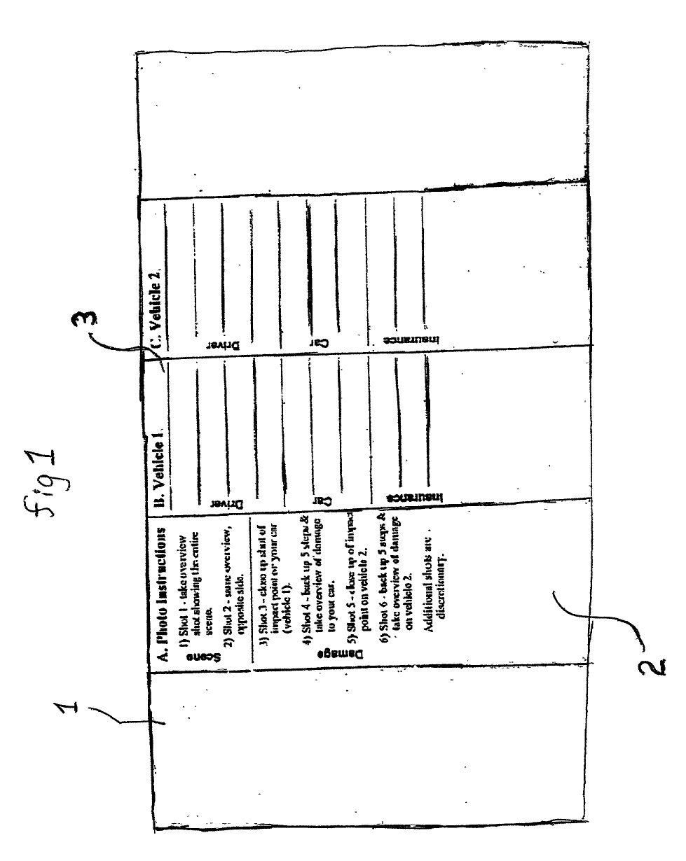

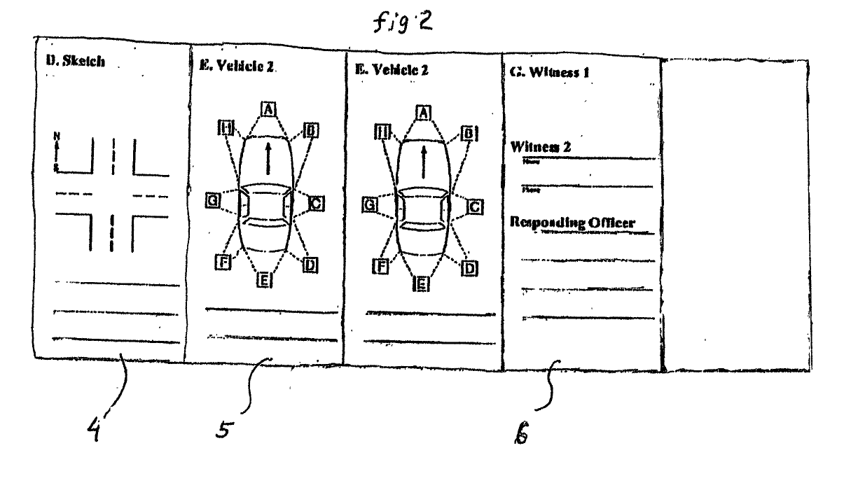

The written forms for use with the kit are illustrated in FIGS. 1-2. There are general instructions (1) for what to do in the case of accident and then instructions (2) as to the photos to be taken. Such information as what direction to take the photos, what to focus on when taking the photos, which photo angles are discretionary ,etc. are included in this section of the form panel 3 has a form for information regarding the two vehicles involved including address, phone, etc. of each driver.

FIG. 2 has panels that provide a form diagram (4) of in intersection for the user to add in, signals, etc. at the accident scene. This includes a pre-printed depiction of an intersection of streets, road shoulders and/or dividing line in order to help the driver (or passenger as the case may bal to locate various significant items and features in the roadway and better enable him to represent the accident scene. Panel 5 has a form diagram of the cars involved in the accident for indicating points of impact and panel 6 has witness and police officer information blanks.

The direction given on the form are clear as only the photos suggested by the forms are to be taken by the user. The user uses the pencil to record points of impact on the generic rerpesentations of automobiles depicted in the form, and to fill out all the spaces requesting information on the form.

Panels of the form may be lettered or numbered as need be. By following the directions on each panel in order, the individual will have both a written and photographic record of the event.

Again, the blanks and exact layout of the forms can vary within the spirit of the invention and such illustration is by way example and is not meant to limit the scope of the invention. There are similar concerns with the wording of the form; such wording on the form is not crucial to the invention nor should the wording limit the scope of the invention in any way,

The kit is sized and shaped so that it can readily fit into the glove compartment of most automobiles. The kit includes a number specific exposure, single use, camera; a form with instructions as to how to create an accurate evidentiary record and a pre sharpened pencil. Together, these items form a unique and invaluable tool designed to be carried in an automobile glove box which will provide drivers with the ability to regain calm, control and protect themselves in the aftermath of an accident situation which might otherwise create additional problems.

I claim:

1. An automobile kit for recording the accident scene of vehicles along with driver information and vehicle damage information and designed for storage within the glove box of an automobile, said kit comprising; a camera and a film cartridge in connection with said camera, said kit including a form for recording the accident, said form having a space for recording vehicle damage information and including depictions of a prototype vehicle and street intersection, said form including written instructions pertaining to how to take photographs of said accident scene; what information to obtain from said drivers, said kit shaped and sized for fitting within the confines of said automobile glove compartments,

2. The kit of claim 1 having in addition a sharpened lead pencil as part of the kit.
